(19) United States
(12) Patent Application Publication
(10) Pub. No.: US 2008/0011490 A1
(43) Pub. Date: Jan. 17, 2008

(54) Alternate foam storage and proportionally mixing device

(76) Inventors: Weishe Zhang, Beijing (CN); Gangjin Li, Beijing (CN)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/824,034

(22) Filed: Jun. 29, 2007

(30) Foreign Application Priority Data
Jun. 30, 2006 (CN) 200610100510.1

(51) Int. Cl. A62C 13/00

(52) U.S. Cl. 169/14

(57) ABSTRACT

The present invention relates to an alternate foam storage and proportionally mixing device, comprising at lest one normal pressure foam storage tank, at least two pressure foam tanks, at least one proportional mixer and a control unit, wherein the foam storage tank is used to store foam liquid and alternatively output the foam liquid to the at least two pressure foam tanks, and the at least two pressure foam tanks alternatively output the foam liquid to the at least one proportional mixer, and the at least one proportional mixer outputs mixed foam liquid. The alternate foam storage and proportionally mixing device has the advantages of accurately mixing foam liquid, simple structure, and rubber diaphragm that tends not to be broken. As a major component of the present invention, the pressure foam tank may be produced in a standard manner, thereby greatly reducing production cycle and cost.

### TECHNICAL FIELD

The present invention relates to a foam storage and proportionally mixing device for a fire extinguisher system, and particularly to an alternate foam storage and proportionally mixing device, by which foam liquid is alternatively injected into at least two pressure foam tanks by means of at least one normal pressure foam storage tank, and the foam liquid from the at least two pressure foam tanks alternatively and continuously produce mixed foam liquid through at least one proportional mixer for the foam fire extinguisher system. The device can be manufactured in a standard manner while not only achieving accurate proportion of mixture of the foam liquid, but can be produced in a simple structure. In addition, the rubber diaphragm tends not to be easily broken. Also, the production cycle is relatively short.

### DESCRIPTION OF THE RELATED ART

There exist two types of foam storage and proportionally mixing devices widely used in the current market, namely, pressure foam storage and proportionally mixing device made of flexible rubber diaphragm, and foam storage and proportionally mixing device of balance pressure regulation, as respectively shown in FIGS. 1 and 2.

FIG. 1 shows a pressure foam storage and proportionally mixing device of the prior art, comprising one pressure foam tank 1 for storing the foam liquid, a proportional mixer 2, a water supply pipe 8, a water intake valve 3, a water outlet valve 7, and a liquid outlet valve 4. The water flowing through the water supply pipe 8 is divided into two portions, one of which flows into the pressure tank 1 through the water intake valve 3 to force the foam liquid stored in advance in the tank 1 into the proportional mixer 2 via the liquid outlet valve 4 through the pipe 5, while the other one of which flows directly into the proportional mixer,2 through the water supply pipe 8. The two portions of liquid are mixed in the proportional mixer 2 to produce a mixed foam liquid in a predetermined proportion of mixture for output. The device is advantageous in the accurate proportion of mixture due to the pressure foam tank and the simple structure. However, because the foam storage tank is in the form of a pressure foam tank, and thus is a pressure container, it has a disadvantage of a long production cycle. Also, because the foam tank is made of rubber diaphragm, it is likely to be broken when it is filled with foam under pressure, and it is more likely to be broken as the tank becomes larger.

FIG. 2 shows a foam storage and proportionally mixing device of balance pressure regulation in the prior art, comprising a normal pressure tank 15, a proportional mixer 12, a foam liquid pump 14, a water pump 16 and an electric control device 17. Various flow parameters such as flux of the foam liquid of the foam liquid pump 14 and the flux of the water pump 16 are measured at first, and then the balance pressure proportional mixer 12 is controlled to output mixed foam liquid according to the various flow parameters. Therefore, it has the advantage of high accuracy of proportion of mixture. Also, since the foam liquid storage tank 14 is a normal pressure tank, the design cycle is shortened. However, the preciseness of the measurement of the parameters and the control may be difficult, that is, sophisticate devices have to be used, thereby increasing the cost.

The above two foam storage and proportionally mixing devices have their respective pros and cons. In order to overcome the disadvantages of long production cycle and tendency to be broken in the flexible rubber diaphragm pressure foam storage and proportionally mixing device, and the disadvantages of difficulty in achieving precise measurement of the parameters and control as well as the high cost in the foam storage and proportionally mixing device of balance pressure regulation, the present invention provides an alternate foam tank and a proportionally mixing device.

### SUMMARY OF THE INVENTION

It is an object of the invention to provide an alternate foam storage and proportionally mixing device, which has the advantages of simple structure and precisely mixing, and is capable to overcome the disadvantages of the long production cycle, the rubber diaphragm being likely to be broken, and difficulty in achieving precise measurement of parameters and precise control.

An alternate foam storage and proportionally mixing device according to the present invention comprising at least one normal pressure foam storage tank, at least two pressure foam tanks, at least one proportional mixer, and a control unit. By using the at least one normal pressure foam storage tank to alternatively inject the foam liquid to the at least two pressure foam tanks, the at least two pressure foam tanks alternatively output the foam liquid to the at least one proportional mixer, which then outputs the mixed foam liquid. Therefore, the foam liquid of the at least two pressure foam tanks are alternatively and continuously output through the at least one proportional mixer to produce the mixed foam liquid for the foam fire extinguisher system.

In the alternate foam storage and proportionally mixing device according to the present invention, whilst one pressure foam tank outputs the foam liquid to the proportional mixer, the at least one normal pressure foam storage tank replenishes liquid to another pressure foam tank.

The alternate foam storage and proportionally mixing device according to the present invention further includes at least two proportional mixers, wherein the pressure foam tanks and the proportional mixers are provided on one-to-one basis, and each of the pressure foam tanks alternatively outputs the foam liquid to the corresponding proportional mixer, and each of the proportional mixer alternatively outputs the mixed foam liquid.

The alternate foam storage and proportionally mixing device according to the present invention further includes at least two foam storage tanks for outputting the foam liquid to the pressure foam tanks. The pressure foam tanks and the foam storage tanks may be provided on one-to-one basis, and the foam storage tanks alternatively output the foam liquid to their respective pressure foam tanks.

The alternate foam storage and proportionally mixing device according to the present invention has the following advantages over the prior art:

1. Since the foam storage tank according to the present invention is a normal pressure tank, and there are at least two pressure foam tanks, the probability of destruction of the rubber diaphragm is greatly decreased. Moreover, the pressure foam tank can be designed in a standard manner, and thus the production can be standardized. Therefore, the present invention can have a short design cycle, and can be manufactured, installed and adjusted easily.

2. Since in the present invention, the normal pressure foam storage tanks are used to store the foam liquid and the pressure foam tanks are used to output the foam liquid, the present invention has the advantages of both aforesaid prior arts, such as simple structure and preciseness of the mixture of the foam liquid, while eliminating the disadvantages of the prior art, such as the difficulty in achieving preciseness of parameter measurement and control. Thus, the present invention has a good economical efficiency.

### BRIEF DESCRIPTION OF THE DRAWING

The present invention will be further described below with reference to the accompanying drawings and the preferred embodiments.

FIG. 1 is a schematic view of a conventional flexible rubber diaphragm pressure foam storage and proportionally mixing device in the prior art;

FIG. 2 is a schematic view of a conventional foam storage and proportionally mixing device of balance pressure regulation in the prior art;

FIG. 3 is a schematic view of a foam storage and proportionally mixing device according to an embodiment of the present invention;

FIG. 4 is a schematic view of a foam storage and proportionally mixing device according to a further embodiment of the present invention;

FIG. 5 is a schematic view of a foam storage and proportionally mixing device according to a still further embodiment of the present invention; and

FIG. 6 is schematic structure view of a piston foam tank according to the present invention.

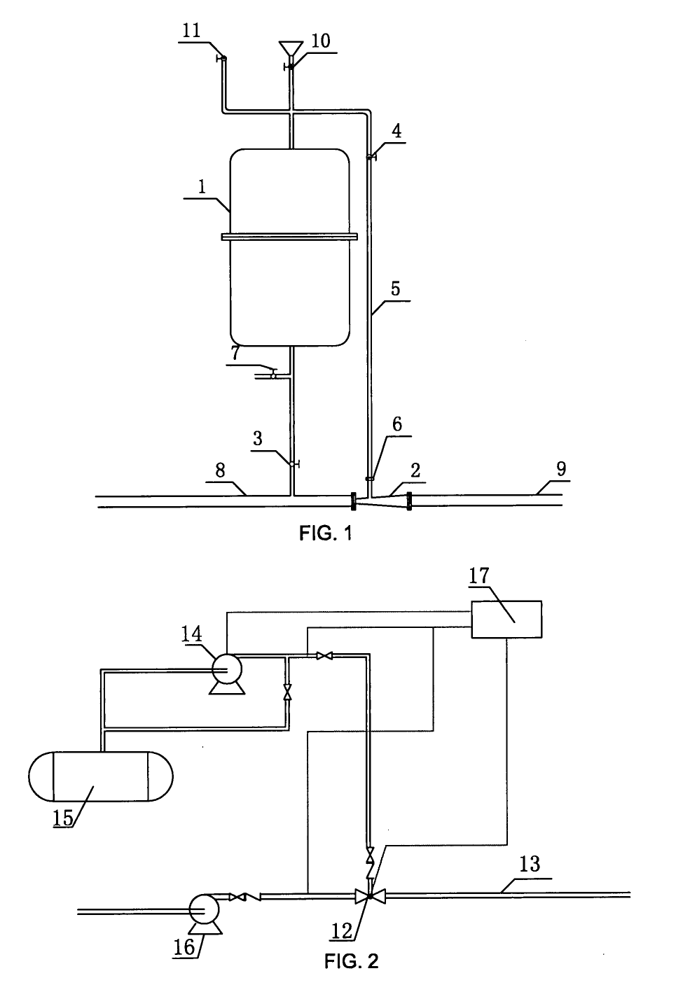

### DESCRIPTION OF THE PREFERRED EMBODIMENT

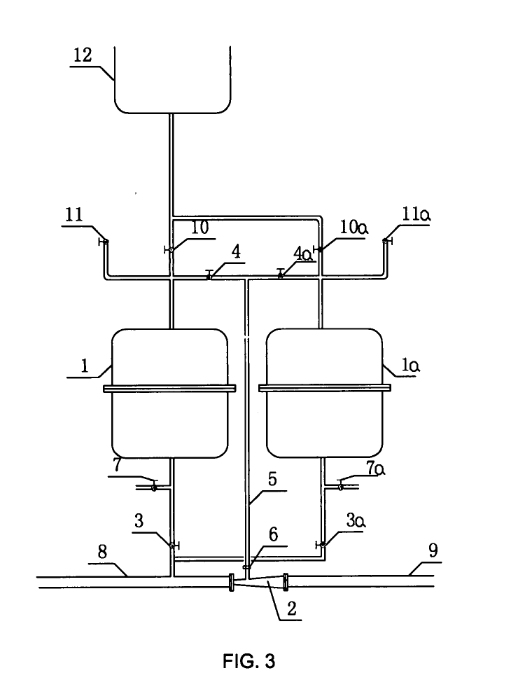

FIG. 3 schematically shows a foam storage and proportionally mixing device according to an embodiment of the present invention. In the embodiment shown in FIG. 3, the foam storage and proportionally mixing device comprises a foam storage tank 12, pressure foam tanks 1, 1a, a proportional mixer 2, water intake valves 3, 3a, water outlet valves 7, 7a, liquid outlet valves 4, 4a, a water supply pipe 8, liquid supply valves 10, 10a, air outlet valves 11, 11a, a control unit (not shown). As shown in FIG. 3, the foam storage tank 12 is connected to the pressure foam tanks 1, 1a for injecting foam liquid into the pressure tanks 1, 1a. The pressure foam tanks 1, 1a are connected to the proportional mixer 2 via a pipe 5 to output the foam liquid thereto. The water supply pipe 8 is connected to the pressure foam tanks 1, 1a as well as the proportional mixer 2 to supply water thereto.

In the alternate foam storage and proportionally mixing device for a foam fire extinguisher system according to the present invention, at least one normal foam storage tank 12 injects foam liquid to the two pressure foam tanks 1, 1a alternatively, and the foam liquid of the two pressure tanks 1, 1a alternatively and continuously produce mixed foam liquid for the foam fire extinguisher system via a proportional mixer 2. The foam storage tank 12 is a normal pressure tank (such as a metal tank, a plastic tank, a barrel having a rated pressure of 0-0.6 MPa). The pressure foam tanks 1, 1a may be piston pressure tanks or pressure tanks provided with a flexible rubber diaphragm, and have a rated pressure greater than 0.6 MPa and a volume in a range of 0.2 to 0.3 m³.

When the foam fire extinguisher system is not in operation as a normal condition, the foam liquid is stored in the normal pressure foam storage tank 12, while the pressure foam tank 1 and 1a is filled with foam liquid. Thus, the water intake valves 3, 3a, water outlet valves 7, 7a, liquid supply valves 10, 10a, air outlet valves 11, 11a, liquid outlet valves 4, 4a are closed. The liquid outlet valves 4, 4a may be one-way valves or electric control valves.

When the foam fire extinguisher system is activated, extinguishing water at certain pressure flows into the water supply pipe 8. The extinguishing water is divided into two portions when entering the proportional mixer 2. The control unit (not shown) sends a signal to open the water intake valve 3 and the liquid outlet valve 4. One portion of the water flows into the pressure foam tank 1, and forces the foam liquid pre-stored in the rubber diaphragm of the pressure foam tank 1 into the proportional mixer 2 via the electric control valve (one-way valve) 4 and a porous plate 6, while another portion of the water flows directly from the water supply pipe 8 into the proportional mixer 2 through a nozzle of the proportional mixer. Here the two parts of liquid are mixed in a predetermined proportion of mixture to produce a mixed foam liquid, which is then discharged to outside. When the control unit detects that the foam liquid stored in the pressure foam tank 1 has been discharged to a certain extent or for a certain time, the control unit sends a signal to close the water intake valve 3 and the liquid outlet valve 4, and open the water intake valve 3a, and the liquid outlet valve 4a. The timing of the opening may be before, after or at the same as that of the closing.

After the water intake valve 3a is opened, similar to the situation in which a portion of water flows into the pressure foam tank 1 through the water supply pipe 8 and the water intake valve 3, at this time, one portion of the water flows into the pressure foam tank 1a, and forces the foam liquid pre-stored in the rubber diaphragm of the pressure foam tank 1a into the proportional mixer 2 via the electric control valve (one-way valve) 4a and a porous plate 6, while another portion of the water flows directly from the water supply pipe 8 into the proportional mixer 2 through a nozzle of the proportional mixer, thereby producing a mixed foam liquid in a predetermined proportion of mixture for output. When the foam liquid from the pressure foam tank 1a is output to the proportional mixer 2, the control unit sends a signal to open the liquid supply valve 10, the air outlet valve 11 and the water outlet valve 7 of the foam tank 1 to inject the foam liquid stored in the form storage tank 12 is into the pressure foam tank 1. Meanwhile, the air in the rubber diaphragm of the foam tank 1 may be discharged through the air outlet valve 11, while the water in the pressure foam tank 1 may be discharged through the water outlet valve 7. When the control unit detects that the foam liquid stored in the pressure foam tank 1 has been output to a certain extent or for a certain time, the control unit sends a signal to close the water intake valve 3a and the liquid outlet valve 4a such that the output from the foam tank 1a to the proportional mixer 2 is stopped, and open the water intake valve 3 and the liquid outlet valve 4 such that the output from the foam tank 1 to the proportional mixer 2 is enabled. The timing of the opening may be before, after or at the same as that of the closing. The control unit opens the liquid supply valve 10a, the air outlet valve 11a and the water outlet valve 7a of the foam tank 1a, and the foam liquid stored in the foam storage tank 12 is injected into the pressure foam tank 1a. As the aforesaid process repeats, the foam tank 12 injects the foam liquid into the pressure foam tanks 1 and 1a alternatively, and the pressure foam tanks 1 and 1a alternatively output the foam liquid into the proportional mixer 2 such that the mixed foam liquid is output from the proportional mixer continuously.

In the present invention, there are various implementations for injecting the foam liquid from the normal pressure foam storage tank 12 into the pressure foam tanks 1 and 1a as desired or depend on the particular situation, such as the following implementations:

1. Injection by head: The normal pressure foam storage tank is positioned at the level higher than the pressure foam tank such that the pressure caused by the head injects the foam liquid from the normal pressure foam storage tank into the pressure foam tank.

2. Injection by pump: A foam pump (not shown) is connected to the foam storage tank and the pressure foam tank, and pumps the foam liquid stored in the normal pressure storage tank into the pressure foam tank.

3. Injection by pneumatic pressure: A pressurizing device (not shown) is connected to the foam storage tank to force the foam liquid into the pressure foam tank by applying a pressurized gas to the liquid surface of the foam stored in the normal pressure foam storage tank.

Although in the aforesaid embodiment, only two pressure foam tanks 1 and 1a are used to alternatively output the foam liquid to the proportional mixer 2, it will be appreciated that more than two pressure foam tanks can be used in the present invention as desired, especially in the situation where the pressure foam tanks are designed in a number of standard configuration. That is, the foam tank may be standardized, and therefore the corresponding foam tank and the number thereof can be selected depend on requirements when designing, thereby greatly reducing the production cycle.

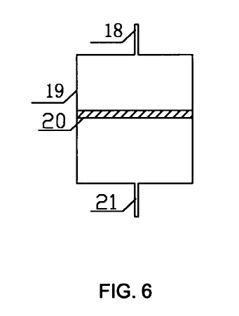

In the present invention, various pressure tanks may be used as the pressure foam tank as desired, such as flexible diaphragm pressure tank or piston pressure tank. A piston pressure tank is shown in FIG. 6. The operation of the piston pressure tank is as follows. When injecting the foam liquid, the foam liquid is delivered into the pressure tank through a in-and-out foam liquid pipe 21 of the piston body 19, and applies a pressure on the piston 20 so as to discharge the water in the pressure tank through an in-and-out water pipe 18. When outputting the foam liquid, water is delivered into the pressure tank through the in-and-out water pipe 18 and applies a pressure on the piston 20. The foam liquid in the pressure tank is output through the in-and-out foam liquid pipe 21.

In the present invention, the output and replenishment of the foam liquid to a pressure foam tank may be detected by, but not limited to the following methods. Alterative method may be adopted as desired.

1. Detection by flow meter: A foam liquid flow meter is disposed on the liquid supply pipe and the liquid outlet pipe for measurement. A flow meter may also be disposed following the water intake valve to measure the flux of the foam liquid by measuring the flux of the water. The supply of the foam liquid is stopped and the replenishment begins when the flux is less than a certain value.

2. Timing control: The two pressure foam tank alternatively replenish and supply the liquid in a certain time interval. The operation thereof is controlled by timing.

3. Position limiting measurement: A displacement switch is disposed on the piston or rubber wall of the pressure foam tank. The amount of the foam liquid in the pressure foam tank is measured by the position of the displacement switch.

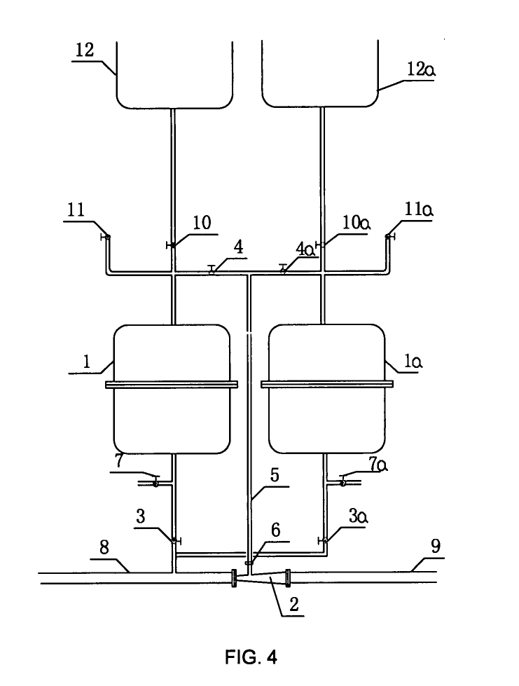

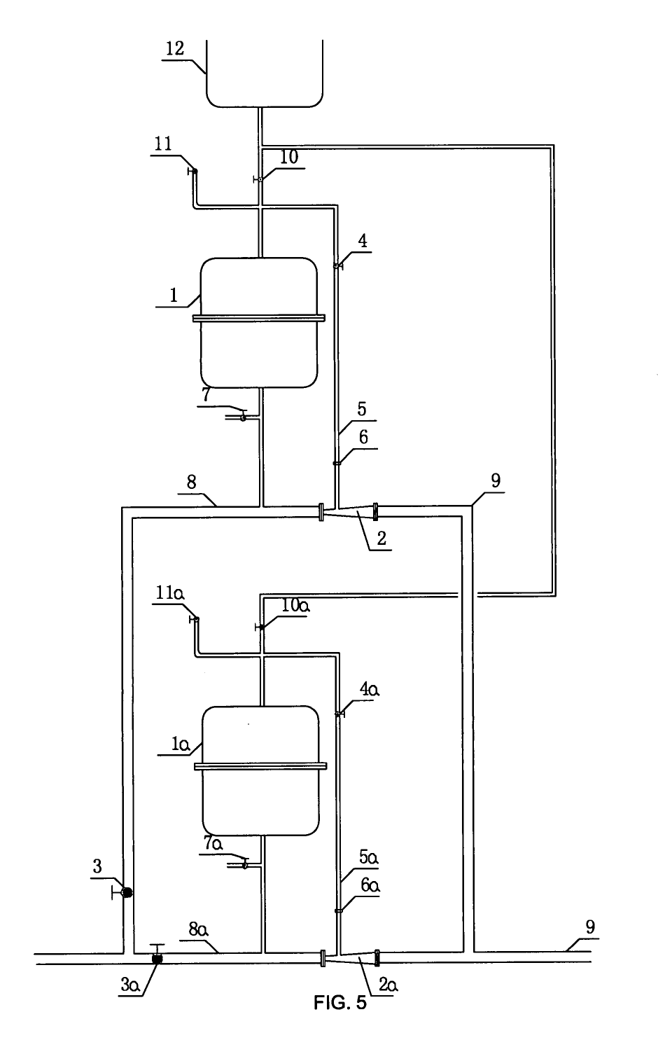

Referring to FIG. 4, which schematically shows a further embodiment of the foam storage and proportionally mixing device of the present invention, the difference between the present embodiment and the aforesaid embodiment lies in that in the present embodiment, the foam storage and proportionally mixing device comprises two foam storage tanks 12, 12a, which are connected to the two pressure foam tanks 1, 1a respectively, and correspond to the two pressure tanks 1 and 1a respectively. The two foam storage tanks 12, 12a alternatively inject the foam liquid to the two respective pressure foam tanks 1 and 1a. Other aspects of the present embodiment are the same with that of the aforesaid embodiment.

Referring to FIG. 5, which schematically shows a still further embodiment of the foam storage and proportionally mixing device of the present invention, the difference between the present embodiment and the aforesaid embodiment lies in that in the present embodiment, the foam storage and proportionally mixing device comprises two proportional mixers 2, 2a, which are connected to the two pressure foam tanks 1, 1a respectively, and correspond to the two pressure tanks 1 and 1a respectively. During operation, the foam liquid in the two pressure foam tank 1, 2a is alternatively and continuously output to their corresponding proportional mixers 2, 2a, which then alternatively output the mixed foam liquid for the foam fire extinguisher system. Moreover, the difference between the present embodiment and the aforesaid embodiments lies in that in the present embodiment, the water intake valves 3, 3a are disposed on the water supply pipes 8, 8a.

The embodiment will be described in detail with reference to FIG. 5.

Before the foam storage and proportionally mixing device according to the present invention operates, that is, when the foam fire extinguisher system has not been activated, in a normal condition, the foam liquid is stored in the normal pressure foam storage tank 12, while the pressure foam tanks 1, 1a are filled with foam liquid. Thus, water intake valves 3, 3a, water outlet valves 7, 7a, liquid supply valves 10, 10a, air outlet valves 11, 11a, liquid outlet valves 4, 4a are closed. The liquid outlet valves 4, 4a may be one way valves, and may also be electric control valves.

When the foam storage and proportionally mixing device according to the present invention operates, that is, when the foam fire extinguisher system is activated, extinguishing water having a predetermined water pressure flows into the main water supply pipe. The control unit may first send a signal to open the water intake valve 3 and the liquid outlet valve 4. The extinguishing water is divided into two portions after entering the water supply pipe 8. One portion of the water flows into the pressure foam tank 1, and forces the foam liquid pre-stored in the rubber diaphragm of the pressure foam tank 1 into the proportional mixer 2 through the liquid outlet valve (electric control valve or one way valve) 4 and the porous plate 6, while the other portion of the water flows directly from the water supply pipe 8 into the proportional mixer 2 through the nozzle of the proportional mixer 2. Here the two parts of liquid are mixed to produce a mixed foam liquid in a predetermined proportion of mixture for subsequent output.

When the control unit detects that the output from the foam tank 1 to the proportional mixer 2 reaches a predetermined value, for example a flow meter detects that the foam liquid stored in the pressure foam tank 1 has been output to a certain extent, or it is otherwise detected that the foam liquid has been output for a certain time, the control unit sends a electric signal to close the water intake valve 3 and the liquid outlet valve 4 such that the output of the foam liquid from the foam tank 1 to the proportional mixer 2 is stopped, and to open the water intake valve 3a and the liquid outlet valve 4a. The timing of the opening may be before, after or at the same as that of the closing. After the water intake valve 3 is closed and the water intake valve 3a is opened, the water which previously flows into the water supply pipe 8 is diverted into the water supply pipe 8a through the water intake valve 3a. Similar to the aforesaid description, the water is divided into two portions. One portion of the water flows into the pressure foam tank 1a to force the foam liquid pre-stored in the rubber diaphragm of the pressure foam tank 1a into the proportional mixer 2a through the liquid outlet valve (electric control valve or one way valve) 4a and the porous plate 6a, while the other portion of the water flows directly from the water supply pipe 8a into the proportional mixer through the nozzle of the proportional mixer 2a, such that a mixed foam liquid with a predetermined proportion of mixture is produced and then output. At the time when the foam liquid stored in the pressure foam tank 1a is forced to be output into the proportional mixer 2a, the control unit sends a signal to open the liquid supply valves 10, air outlet valves 11 and water outlet valve 7 such that the foam liquid in the foam storage tank 12 is injected into the pressure foam tank 1, while the air in the rubber diaphragm may be discharged through the air outlet valve 11, and the water in the pressure foam tank may be discharged through the water outlet valve 7. When the flow meter (not shown) detects that the foam liquid stored in the pressure foam tank la has been output to certain extent or for a certain time, the control unit sends a electric signal to close the water intake valve 3a and the liquid outlet valve 4a, and to open the water intake valve 3 and the liquid outlet valve 4. The timing of the opening may be before, after or at the same as that of the closing. Thus, the aforesaid process of output and replenishment of the foam liquid in each of the pressure foam tanks repeats, and the pressure foam tanks are replenished alternatively with the foam liquid, while the pressure foam tank alternatively outputs the foam liquid to its corresponding proportional mixer, such that the mixed foam liquid is supplied continuously from the proportional mixers for the fire extinguisher system for extinguishing fire.

Obviously, the normal pressure foam storage tank described in the present invention may be one tank, and may also be a group of tanks or groups of tanks formed by a plurality tanks connected in parallel. According to a particular requirement or circumstance, the replenishment of liquid from groups or a plurality of foam storage tanks to a plurality of pressure foam tank may be implemented on one-to-one basis. Alternatively, the liquid may be replenished in sequence of the tanks or groups of tanks. That is, after the foam liquid in a tank or a group of tanks is used up, next tank or next group of tanks is sequentially used to replenish the liquid.

The alternate foam storage and proportionally mixing device may be used in various foam fire extinguisher system, such as open-type foam fire extinguisher system, enclosed-type foam fire extinguisher system, low expansion foam fire extinguisher system, medium expansion foam fire extinguisher system and high expansion foam fire extinguisher system, etc.

1. An alternate foam storage and proportionally mixing device for a foam extinguisher system, comprising at least one normal pressure foam storage tank, at least two pressure foam tanks, at least one proportional mixer, and a control unit, wherein the foam storage tank is configured to store foam liquid and alternatively inject the foam liquid to the at least two pressure foam tanks, and wherein the at least two pressure foam tanks alternatively output the foam liquid to the at least one proportional mixer, which outputs a mixed foam liquid.

2. The alternate foam storage and proportionally mixing device according to claim 1, characterized in that whilst one pressure foam tank outputs the foam liquid to the proportional mixer, the at least one normal pressure foam storage tank replenishes liquid to the other pressure foam tank.

3. The alternate foam storage and proportionally mixing device according to claim 1, further comprising at least two proportional mixers, wherein the pressure foam tanks and the proportional mixers are provided on one-to-one basis, and the pressure foam tanks alternatively output foam liquid to their respective proportional mixers, and the at least two proportional mixers alternatively output the mixed foam liquid.

4. The alternate foam storage and proportionally mixing device according to claim 1, further comprising at least two foam storage tanks for injecting the foam liquid into the pressure foam tanks.

5. The alternate foam storage and proportionally mixing device according to claim 4, further comprising at least two proportional mixers, wherein the pressure foam tanks and the proportional mixers are provided on one-to-one basis, and the pressure foam tanks alternatively output foam liquid to their respective proportional mixers, and the at least two proportional mixers alternatively output the mixed foam liquid.

6. The alternate foam storage and proportionally mixing device according to claim 4, characterized in that the pressure foam tanks and the foam storage tanks are provided on one-to-one basis, and the foam storage tanks alternatively output foam liquid to their respective pressure foam tanks.

7. The alternate foam storage and proportionally mixing device according to claim 6, further comprising at least two proportional mixers, wherein the pressure foam tanks and the proportional mixers are provided on one-to-one basis, and the pressure foam tanks alternatively output foam liquid to their respective proportional mixers, and the at least two proportional mixers alternatively output the mixed foam liquid.

8. The alternate foam storage and proportionally mixing device according to any one of claims 1-7, characterized in that the foam liquid is output from the foam storage tank to the pressure foam tanks by means of head.

9. The alternate foam storage and proportionally mixing device according to any one of claims 1-7, characterized in that the foam liquid is output from the foam storage tank to the pressure foam tanks by means of pumping.

10. The alternate foam storage and proportionally mixing device according to any one of claims 1-7, characterized in that the foam liquid is output from the foam storage tank to the pressure foam tanks by pneumatic pressure.

11. The alternate foam storage and proportionally mixing device according to any one of claims 1-7, characterized in that the pressure foam tank is a flexible rubber diaphragm pressure tank.

12. The alternate foam storage and proportionally mixing device according to any one of claims 1-7, characterized in that the pressure foam tank is a piston pressure tank.
